(19) United States
(12) Patent Application Publication
(10) Pub. No.: US 2020/0005220 A1
(43) Pub. Date: Jan. 2, 2020

(54) METHOD AND SYSTEM FOR RECRUITING CANDIDATES

(71) Applicant: Angela Lynn HOOD, Austin, TX (US)

(72) Inventor: Angela Lynn HOOD, Austin, TX (US)

(21) Appl. No.: 16/484,590

(22) PCT Filed: Feb. 13, 2018
(86) PCT No.: PCT/EP2018/025038

§ 371 Date: Aug. 8, 2019

(30) Foreign Application Priority Data
Feb. 13, 2017 (GB) 1702350.8

(51) Int. Cl. G06Q 10/06; G06Q 10/10

(52) U.S. Cl. CPC G06Q 10/063112; G06Q 10/1053

(57) ABSTRACT

Disclosed is a method for identifying at least one job opening provided by at least one recruiter company and presenting the at least one job opening to at least one job seeker, the method comprising:
(i) identifying the at least one job seeker;
(ii) identifying the at least one recruiter company;
(iii) identifying the at least one job opening associated with the at least one recruiter company;
(iv) implementing a recommendation algorithm to match the at least one job seeker to the at least one job opening; and
(v) recommending the at least one job opening in real time to the at least one job seeker when the at least one job seeker uses an Augmented Reality (AR) enabled-device to receive information about the at least one job opening.

### TECHNICAL FIELD

The present disclosure relates generally to job searching services, and more particularly to a system and a method for mapping and displaying at least one job opening provided by at least one recruiter company using augmented reality technology.

### BACKGROUND

In recent years, Augmented Reality (AR) has emerged as the next generation technology applied to enhance user experience in virtual reality. In principle, Augmented reality technologies aim to blend data or information stored on a data storage server with images or perceptions of the real world. For example, using a computer or a mobile device, a user can overlap previously stored information with an image acquired (for example a photograph) resulting in the user perceiving additional features. Such features can be any stored information such as one or more other images, videos, text, sounds etc.

The key function of augmented reality is to enhance user perceptions of the real world. Therefore, any stored information must be blend with real world perceptions in an intelligent way. Intelligent blending of information and real world perceptions may be achieved both by adding information to one or more perceptions as well as recognizing and removing features acquired in the real world. Examples could be to add in real time a tag (e.g. a price) to an image a user acquires with a mobile device (e.g. a car on the street) or to removing background noise from a public location with the help of a second device especially set for Augmented Reality.

The availability of 3-dimensional videos, virtual reality and AR technology enables a user to perform actions or processes higher precision while elimination drawbacks associated with inefficiencies inherent in traditional processes. Such actions or processes can be applied to, for example, the entertainment industry where a user of AR could, for example, view the food served in a restaurant or hear the music played in a night club simply by looking at those locations through a AR-enabled device. A person with an interest of buying an automobile, could simple walk around a given street and, by looking through an AR-enabled device get all information he or she needs to buy a similar automobile, not least alternatives with higher specification but lower price. In the above examples, a consumer would significant decrease or even eliminate the drawbacks associated with the actions or processes. For example, the buyer of the automobile would be presented with the choice of buying a similar alternative at a better price or one with a closer match to specifications sought instantly or in a relatively short period. Therefore, the time and/or costs associated with the process of buying the automobile would significantly decrease while the precision of the product-buyer match (i.e. car buyer match with car sought at desired price and location) would significantly increase.

Currently, a key problem in the job seeking placement market is that lees than 50% of the jobs available are advertised. Moreover, conventional methods available for job seekers tend to be on large job data banks and online platforms which tend to lead to imprecise choices by the job seeker or recruiting party. In light of the foregoing discussion, there exists a particular opportunity to significantly improve drawbacks associated with conventional techniques and processes used by a job seeker to find a job matching expectations of the job seeker and expectations of the employer.

However, available search tools either require the job seeker to go through a large number of search results or a search can return no results if the keywords defined by the job seeker are to unique or narrow.

Accordingly, it would be appreciated, to provide profile matching tool that more intelligently matches the job description, accurately matches the skills and trails of job seeker to the skill set required by the recruiter and recommends the job opening to the job seeker.

### SUMMARY

The present disclosure seeks to provide a method for enhancing the experience of a job seeker when seeking a job. Moreover, the present disclosure seeks to provide at least one job opening provided by at least one recruiter company to a job seeker.

In an aspect, an embodiment of the present disclosure provides a method for identifying at least one job opening provided by at least one recruiter company and presenting the at least one job opening to at least one job seeker, the method comprising:
(i) identifying the at least one job seeker;
(ii) identifying the at least one recruiter company;
(iii) identifying the at least one job opening associated with the at least one recruiter company;
(iv) implementing a recommendation algorithm to match the at least one job seeker to the at least one job opening; and
(v) recommending the at least one job opening in real time to the at least one job seeker when the at least one job seeker uses an Augmented Reality (AR) enabled-device to receive information about the at least one job opening.

Optionally, the at least one job seeker is a person actively or inactively aiming to find a job. More optionally, identifying the at least one job seeker comprises receiving information from the at least one job seeker, and/or harvesting relevant information about the at least one job seeker from a computer network.

Optionally, identifying the at least one recruiter company comprises receiving information from the at least one recruiter company and/or by harvesting relevant information about the at least one job seeker from a computer network.

Optionally, identifying the at least one job opening comprises receiving information from the at least one recruiter company and/or identifying at least one potential job opening by receiving information from a person employed by an employer or from the employer that the employment of the person will be terminating the employment at a future date.

Optionally, recommending the at least one job opening to the at least one job seeker comprises presenting the information via an intelligent blend of the information related to: the job opening, the recruiter company or any other relevant information with one or more real world images acquired by the user of the AR enabled device.

Optionally, the method further comprises storing the information required for identifying: the at least one job seeker, the at least one recruiter company and/or identifying the at least one job opening.

Optionally, the method further comprises using a portable communication device as an Augmented Reality (AR) enabled device. More optionally, the method further comprises using a lens adapted to the portable communication device for enabling Augmented Reality technology at the portable communication device.

In another aspect, an embodiment of the present disclosure provides A system for identifying at least one job opening provided by at least one recruiter company and presenting the at least one job opening to at least one job seeker, the system comprising: a server, a user device associated with the at least one job seeker and a recruiter device associated with the at least one recruiter company, wherein the server, the user device and the recruiter device are connected via a communication network, the system comprising:
(i) a identifying module for identifying the at least one job seeker;
(ii) a identifying module for identifying at least one recruiter company;
(iii) a identifying module for identifying the at least one job opening associated with the at least one recruiter company;
(iv) an implementation module for implementing a recommendation algorithm to match the at least one job seeker to the at least one job opening; and
(v) a recommendation module for recommending the at least one job opening in real time to the at least one job seeker when the at least one job seeker uses an Augmented Reality (AR) enabled-device to receive information about the at least one job opening.

Optionally, the job seeker is a person actively or inactively aiming to find a job. More optionally, the identifying module for identifying the at least one job seeker is operable for receiving information from the at least one job seeker, and/or harvesting relevant information about the job seeker from a computer network.

Optionally, the identifying module for identifying the at least one recruiter company is operable for receiving information from the at least one recruiter company and/or by harvesting relevant information about the at least one job seeker from a computer network.

Optionally, the identifying module for identifying the at least one job opening is operable for receiving information from the at least one recruiter company and/or identifying at least one potential job opening by receiving information from a person employed by an employer or from the employer that the employment of the person will be terminating the employment at a future date.

Optionally, the recommendation module is operable for presenting the information via an intelligent blend of the information related to: the job opening, the recruiter company or any other relevant information with one or more real world images acquired by the user of the AR enabled device.

Optionally, the system further comprises a database for storing the information required for identifying: the at least one job seeker, the at least one recruiter company and/or identifying the at least one job opening.

Optionally, the system is further operable for using a portable communication device as an Augmented Reality (AR) enabled device. More optionally, the system is further operable for using a lens adapted to the portable communication device for enabling Augmented Reality technology at the portable communication device.

Advantageously, then, the job seeker being able to view jobs available in real time, at a particular building, house or location, including, where available, a pre-view and insight of internal conditions.

Embodiments of the present disclosure substantially eliminate or at least partially address the aforementioned problems in the prior art, and provide an efficient method and system for identifying at least one job opening provided by at least one recruiter company and presenting the at least one job opening to at least one job seeker.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a detailed illustration of steps of the method for identifying at least one job opening provided by at least one recruiter company and presenting the at least one job opening to at least one job seeker, in accordance with various embodiments of the present disclosure; and

FIG. 2 is a schematic illustration of a system for identifying at least one job opening provided by at least one recruiter company and presenting the at least one job opening to at least one job seeker, in accordance with various embodiments of the present disclosure.

### DETAILED DESCRIPTION

Description of embodiments of the present disclosure is not intended to limit the scope of claims of the present disclosure. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

Functional units described in this disclosure have been labelled as systems or devices. A module, device, or a system may be implemented in programmable hardware devices such as, processors, digital signal processors, central processing units, field programmable gate arrays, programmable array logic, programmable logic devices, cloud processing systems, or the like. The devices/modules may also be implemented in software for execution by various types of processors. An identified device/module may include executable code and may, for example, comprise one or more physical or logical blocks of computer instructions, which may be, for example, organized as an object, procedure, function, or other construct. Nevertheless, the executable of an identified device/module need not be physically located together, but may comprise disparate instructions stored in different locations which, when joined logically together, comprise the device and achieve the stated purpose of the device.

Indeed, an executable code of a device could be a single instruction, or many instructions, and may even be distributed over several different code segments, among different applications, and across several memory devices.

Similarly, operational data may be identified and illustrated herein within the device, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the disclosed subject matter. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

It will be appreciated that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

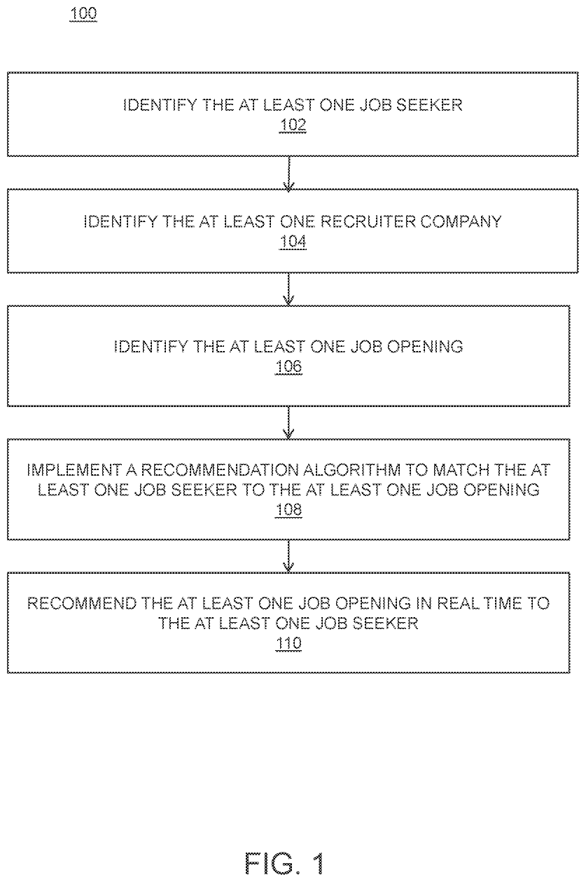

In FIG. 1 illustrated are steps of a method 100 for identifying at least one job opening provided by at least one recruiter company and presenting the at least one job opening to at least one job seeker, in accordance with an embodiment of the present disclosure.

At step 102 at least one job seeker is identified; at Step 104 at least one recruiter company is identified and at step 106 at least one job opening is identified. At step 108 a recommendation algorithm is implemented to match the at least one job seeker to the at least one job opening and at step 110 the at least one job opening is recommended to the matched at least one job seeker on real time basis when the at least one job seeker is using an Augmented Reality (AR) enabled-device to receive information about the at least one job opening.

In an embodiment, the at least one job seeker may be a person actively aiming to find out a job. In another embodiment, the at least one job seeker may be a person inactively aiming to find out a job.

In an embodiment, the step 102 identifying the at least one job seeker may include receiving information from the at least one job seeker, and/or harvesting relevant information about the at least one job seeker from a computer network.

In another embodiment, the step 104 identifying the at least on recruiter company may include receiving information from the at least one recruiter company and/or by harvesting relevant information about the at least one job seeker from a computer network.

In yet another embodiment, the step 106 identifying the at least one job opening may include receiving information from the at least one recruiter company and/or identifying at least one potential job opening by receiving information from a person employed by an employer or from the employer that the employment of the person will be terminating the employment at a future date.

In an embodiment, the step 108 recommending the at least one job opening in real time to the at least one job seeker may include presenting the information via an intelligent blend of the information related to: the job opening, the recruiter company or any other relevant information with one or more real world images acquired by the user of the AR enabled device.

In another embodiment, the method 100 may further include storing the information required for identifying: the at least one job seeker, the at least one recruiter company and/or identifying the at least one job opening.

In yet another embodiment, the method 100 may further include using a portable communication device as an Augmented Reality (AR) enabled device. In this embodiment, the method 100 may further include using a lens adapted to the portable communication device for enabling Augmented Reality technology at the portable communication device.

In an exemplary embodiment, the job seeker may be a job seeker actively or inactively seeking employment. Here, actively looking for employment has the meaning of a person searching of a job through the various currently available methods. Meanwhile a person ‘inactively looking for employment’ has a meaning of a person performing actions or disclosing information that could indirectly lead to the need of that person to seek employment—for example a notification by the person to his or her employer or a notification form an employer to the person that employment will be terminated at a particular date. The recruiter company may be an organization having at least one job opening and is willing to hire candidates (such as the job seeker). Alternatively, the recruiter company may be a job consultancy company associated with at least one organization providing the at least one job opening to the candidate (such as the job seeker).

In another embodiment, the recruiter company may be identified by receiving and storing information of various companies looking to hire desirable candidates.

In yet another embodiment, the recruiter company may be identified by receiving and storing information of various companies in which the at least one job seeker may be applying for the at least one job opening.

In an embodiment, the at least on job opening may be identified by receiving and storing information of the companies having opening for a job position.

In yet another embodiment, identifying the at least one job opening may include by receiving information from a person employed by an employer or from the employer that the employment of the person will be terminating the employment at a future date.

In an embodiment, implementing the recommendation algorithm to match the at least one job seeker to the at least one job opening may include comparing personal and professional traits of the job seeker to the desired traits of the recruiter company for the at least one job opening.

The term “passport” or “professional passport” referred to identified desired skills by the recruiter company aptitude of the candidate work related information of the recruiter company. In an embodiment, the professional passport is an online dynamic document which is updated directly by the recruiter company and the job matching system (for example, via a learning algorithm, described herein later).

In an embodiment, at step 108 identification of the at least one job opening may include but not limited to the traditional methods of identifying job opening, such as data harvested from third party data bases as well as data directly input by candidates. In this embodiment, the data harvested from third party data bases may include the information such as location, place of work, office, company type, job function, testimony from others, social media traits and so forth.

In another embodiment, identifying or predicting job opening may include identifying job opening at a particular location at a particular timing by matching location, position, job title and all relevant information of a currently employed candidate who starts the process for searching a new job, by input data on the clients' platform or contact recruiters or exhibit particular behavior on job searching platforms.

In another embodiment, prediction of job opening may occur with different level of confidence, especially with respect to timing. For example—100% confidence occur when a candidate is employed in employer A, but signs a contract with Employer B to start on a particular date.

In an embodiment, the recommendation algorithm may match and place job opening data on a map, including all available tags (to increase matching confidence) and make information available by augmented reality users devices, for example user mobile device.

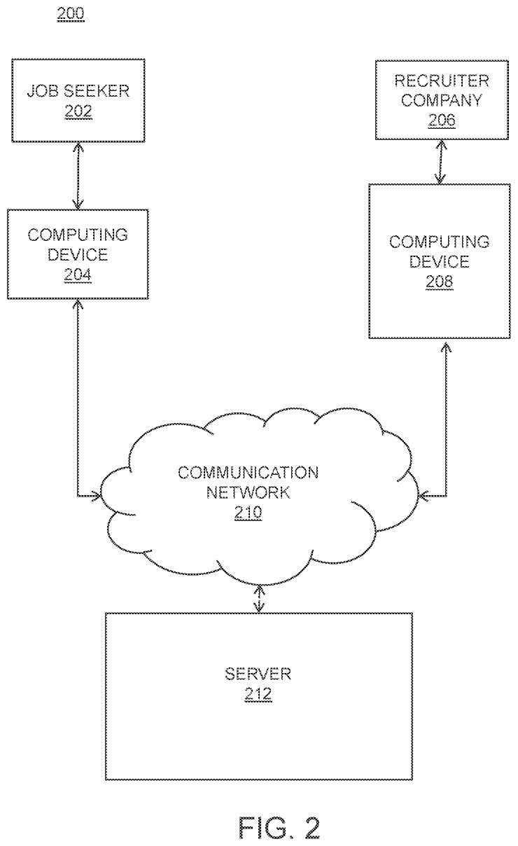

In FIG. 2 illustrated is a schematic illustration of a system 200 for identifying at least one job opening provided by at least one recruiter company and presenting the at least one job opening to at least one job seeker, in accordance with various embodiments. As shown in FIG. 2 the system 200 includes at least one job seeker 202, a user device 204, recruiter company 206 and recruiter device 208 connected to a server 212 via a communication network 210. The system 200 includes an identifying module for identifying the at least one job seeker 202, an identifying module for identifying the at least one recruiter company 206, an identifying module for identifying the at least one job opening associated with the at least one recruiter company 206, an implementation module for implementing a recommendation algorithm to match the at least one job seeker 202 to the at least one job opening and a recommendation module for recommending the at least one job opening in real time to the at least one job seeker 202 when the at least one job seeker 202 uses an Augmented Reality (AR) enabled-device to receive information about the at least one job opening.

In an embodiment, the at least one job opening may be associated with any field of work but not limited to, sales, engineering, marketing, software developing, accounting, medicine, hospitality, aviation, cooking, fashion designing, law and security services.

In an embodiment, the user devices 204 and recruiter device 208 may include cell phones, phablet computers, tablet computers, desktop computers, personal digital assistants (PDA), and so forth. A typical example of the devices 204 and 208 is a wireless data access-enabled device, for example, an iPHONE® smart phone, a BLACKBERRY® smart phone, a NEXUS ONE™ smart phone, an iPAD® device, and so forth, that is capable of sending and receiving data in a wireless manner using protocols like the internet protocol (IP), and the wireless application protocol (WAP).

In an embodiment, the data communication network 210 may be wired, wireless or a combination thereof. According to an embodiment, the communication network 210 includes, but is not limited to, Local Area Networks (LANs), Wide Area Networks (WANs), Metropolitan Area Networks (MANs), Wireless LANs (WLANs), Wireless WANs (WWANs), Wireless MANs (WMANs), the Internet, second generation (2G) telecommunication networks, third generation (3G) telecommunication networks, fourth generation (4G) telecommunication networks, and Worldwide Interoperability for Microwave Access (WiMAx) networks.

The system 200 is operable to receive information describing the at least one job opening by the recruiter company 204. The information describing the at least one job opening comprises job description, desired traits and skills in candidates 202.

In an exemplary embodiment, the job seeker 202 may be a job seeker 202 actively or inactively seeking employment. Here, actively looking for employment has the meaning of a person searching of a job through the various currently available methods. Meanwhile a person ‘inactively looking for employment’ has a meaning of a person performing actions or disclosing information that could indirectly lead to the need of that person to seek employment—for example a notification by the person to his or her employer or a notification form an employer to the person that employment will be terminated at a particular date. The recruiter company 206 may be an organization having at least one job opening and is willing to hire candidates (such as the job seeker 202). Alternatively, the recruiter company 206 may be a job consultancy company associated with at least one organization providing the at least one job opening to the candidate (such as the job seeker 202).

In an embodiment, the identifying module for identifying the at least one job seeker 202 may be operable for receiving information from the at least one job seeker 202, and/or harvesting relevant information about the job seeker 202 from a computer network 210.

In another embodiment, the identifying module for identifying the at least one recruiter company 206 may be operable for receiving information from the at least one recruiter company 206 and/or by harvesting relevant information about the at least one job seeker 202 from a computer network 214.

In another embodiment, the identifying module for identifying the at least one job opening may be operable for receiving information from the at least one recruiter company 206 and/or identifying at least one potential job opening by receiving information from a person employed by an employer or from the employer that the employment of the person will be terminating the employment at a future date.

In yet another embodiment, the recommendation module may be operable for presenting the information via an intelligent blend of the information related to: the job opening, the recruiter company 206 or any other relevant information with one or more real world images acquired by the user of the AR enabled device.

In another embodiment, the system 200 may further include a database for storing the information required for identifying: the at least one job seeker 202, the at least one recruiter company 206 and/or identifying the at least one job opening.

In yet another embodiment, the system 200 may further include using a portable communication device as an Augmented Reality (AR) enabled device. In this embodiment, the system 200 may further include using a lens adapted to the portable communication device for enabling Augmented Reality technology at the portable communication device.

The present disclosure provides a method and a system of mapping at least one job opening provided by at least one recruiter company to candidate profiles. The disclosed method and system is beneficial in terms of Job seeker being able to view jobs available in real time, at a particular building, house or location, including, where available, a pre-view and insight of internal conditions, increase job satisfaction, average time on a job, and personal satisfaction. In addition, the disclosed method and system determines desired traits for a job opening in the recruiter company, such as personality characteristics, personal features such as being creative and so forth. The disclosed method and system further take into consideration these traits while finding the candidates for the job opening. Furthermore, the disclosed method and system ranks the profiles of the candidates to a job opening, and then recommends the high ranked candidate profiles to a job opening. Further the disclosed method and system provide a more intelligent and accurate tool to the recruiters as it is capable of filtering the skills and traits in candidate profiles and removing the similar skills and traits written in different manner.

While the disclosure has been presented with respect to certain specific embodiments, it will be appreciated that many modifications and changes may be made by those skilled in the art without departing from the spirit and scope of the disclosure. It is intended, therefore, by the appended claims to cover all such modifications and changes as fall within the true spirit and scope of the disclosure.

1. A method for identifying at least one job opening provided by at least one recruiter company and presenting the at least one job opening to at least one job seeker, the method comprising:
(i) identifying the at least one job seeker;
(ii) identifying the at least one recruiter company;
(iii) identifying the at least one job opening associated with the at least one recruiter company;
(iv) implementing a recommendation algorithm to match the at least one job seeker to the at least one job opening; and
(v) recommending the at least one job opening in real time to the at least one job seeker when the at least one job seeker uses an Augmented Reality (AR) enabled-device to receive information about the at least one job opening.

2. The method according to claim 1, wherein the at least one job seeker is a person actively or inactively aiming to find a job.

3. The method according to claim 1, wherein identifying the at least one job seeker comprises receiving information from the at least one job seeker, and/or harvesting relevant information about the at least one job seeker from a computer network.

4. The method according to claim 1, wherein identifying the at least one recruiter company comprises receiving information from the at least one recruiter company and/or by harvesting relevant information about the at least one job seeker from a computer network.

5. The method according to claim 1, wherein identifying the at least one job opening comprises receiving information from the at least one recruiter company and/or identifying at least one potential job opening by receiving information from a person employed by an employer or from the employer that the employment of the person will be terminating the employment at a future date.

6. The method according to claim 1, wherein recommending the at least one job opening to the at least one job seeker comprises presenting the information via an intelligent blend of the information related to: the job opening, the recruiter company or any other relevant information with one or more real world images acquired by the user of the AR enabled device.

7. The method according to claim 1, the method further comprises storing the information required for identifying: the at least one job seeker, the at least one recruiter company and/or identifying the at least one job opening.

8. The method according to claim 1, the method further comprises using a portable communication device as an Augmented Reality (AR) enabled device.

9. The method according to claim 8, the method further comprises using a lens adapted to the portable communication device for enabling Augmented Reality technology at the portable communication device.

10. A system for identifying at least one job opening provided by at least one recruiter company and presenting the at least one job opening to at least one job seeker, the system comprising: a server, a user device associated with the at least one job seeker and a recruiter device associated with the at least one recruiter company, wherein the server, the user device and the recruiter device are connected via a communication network, the system comprising:
(i) a identifying module for identifying the at least one job seeker;
(ii) a identifying module for identifying at least one recruiter company;
(iii) a identifying module for identifying the at least one job opening associated with the at least one recruiter company;
(iv) an implementation module for implementing a recommendation algorithm to match the at least one job seeker to the at least one job opening; and
(v) a recommendation module for recommending the at least one job opening in real time to the at least one job seeker when the at least one job seeker uses an Augmented Reality (AR) enabled-device to receive information about the at least one job opening.

11. The system according to claim 10, wherein the job seeker is a person actively or inactively aiming to find a job.

12. The system according to claim 10, wherein the identifying module for identifying the at least one job seeker is operable for receiving information from the at least one job seeker, and/or harvesting relevant information about the job seeker from a computer network.

13. The system according to claim 10, wherein the identifying module for identifying the at least one recruiter company is operable for receiving information from the at least one recruiter company and/or by harvesting relevant information about the at least one job seeker from a computer network.

14. The system according to claim 10, wherein the identifying module for identifying the at least one job opening is operable for receiving information from the at least one recruiter company and/or identifying at least one potential job opening by receiving information from a person employed by an employer or from the employer that the employment of the person will be terminating the employment at a future date.

15. The system according to claim 10, wherein the recommendation module is operable for presenting the information via an intelligent blend of the information related to: the job opening, the recruiter company or any other relevant information with one or more real world images acquired by the user of the AR enabled device.

16. The system according to claim 10, wherein the system further comprises a database for storing the information required for identifying: the at least one job seeker, the at least one recruiter company and/or identifying the at least one job opening.

17. The system according to claim 10, wherein the system is further operable for using a portable communication device as an Augmented Reality (AR) enabled device.

18. 17. The system according to claim 17, wherein the system is further operable for using a lens adapted to the portable communication device for enabling Augmented Reality technology at the portable communication device.
